(19) United States
(12) Patent Application Publication
(10) Pub. No.: US 2013/0205273 A1
(43) Pub. Date: Aug. 8, 2013

(54) POWER SUPPLY WIRING DESIGN SUPPORT METHOD, POWER SUPPLY WIRING DESIGN SUPPORT APPARATUS, POWER SUPPLY WIRING DESIGN SUPPORT PROGRAM AND RECORDING MEDIUM

(71) Applicant: Tomoyuki YODA, Kanagawa (JP)

(72) Inventor: Tomoyuki YODA, Kanagawa (JP)

(73) Assignee: Kabushiki Kaisha Toshiba, Tokyo (JP)

(21) Appl. No.: 13/587,365

(22) Filed: Aug. 16, 2012

(30) Foreign Application Priority Data
Feb. 8, 2012 (JP) 2012-025347

(51) Int. Cl. G06F 17/50

(52) U.S. Cl. 716/127

(57) ABSTRACT

A power supply wiring design support method of an embodiment includes: receiving input of information about multiple elements formed on a semiconductor chip and circuit information about the semiconductor chip; calculating a voltage drop of power supply voltage in each of areas into which the semiconductor chip is virtually divided based on a grid indicated by XY coordinates; and calculating a voltage drop gradient from the voltage drop of the area and voltage drops of adjacent areas.

### CROSS-REFERENCE TO RELATED APPLICATION

This application claims the benefit of Japanese Application No. 2012-025347 filed in Japan on Feb. 8, 2012, the contents of which are incorporated herein by this reference.

### FIELD

Embodiments described herein relate generally to a power supply wiring design support method, a power supply wiring design support apparatus and a power supply wiring design support program for a semiconductor chip, and a recording medium for recording the power supply wiring design support program.

### BACKGROUND

With miniaturization and higher speeds of semiconductor integrated circuits, there is a problem of occurrence of a malfunction due to a local voltage drop inside a semiconductor chip. In order to prevent the voltage drop, reinforcement of power supply wiring, such as increase in width of power supply wires or increase in the number of power supply wires, is effective. However, reinforcement of power supply wiring makes it difficult to design layout of general signal wiring. Therefore, it is necessary to effectively perform the reinforcement.

A design support system using a computer is used for power supply wiring design for a semiconductor chip. For example, the system sets a virtual grid on a semiconductor chip to divide the semiconductor chip into multiple areas, extracts an electrical characteristic of each area, determines, for each area, electric potential in the area and a current flowing through the area, based on the obtained electrical characteristic, on the assumption that the electric potential in the area is constant, and displays the electric potential and the current. Furthermore, the system calculates a voltage drop of each area and displays the voltage drop on the layout of the semiconductor chip as a map.

A system is also proposed which searches for a current route which flows into a node with a largest voltage drop on a circuit of a semiconductor chip connected by nodes and automatically reinforces wiring which is a bottleneck on the current route.

### BRIEF DESCRIPTION OF THE DRAWINGS

FIG. 1 is a block diagram of a power supply wiring design support apparatus of a first embodiment;

FIG. 2 is a diagram for illustrating virtual division of a semiconductor chip in a power supply wiring design support method of the first embodiment;

FIG. 3 is a diagram for illustrating virtual division of the semiconductor chip in the power supply wiring design support method of the first embodiment;

FIG. 4 is a diagram showing an example of a voltage drop in the power supply wiring design support method of the first embodiment;

FIG. 5 is a diagram showing an example of a voltage drop gradient in the power supply wiring design support method of the first embodiment;

FIG. 6 is a diagram showing an example of a voltage drop gradient map in the power supply wiring design support method of the first embodiment;

FIG. 7 is a flowchart for illustrating a flow of a process of the power supply wiring design support method of the first embodiment;

FIG. 8 is a diagram showing an example of the voltage drop gradient map in the power supply wiring design support method of the first embodiment;

FIG. 9 is a block diagram of a power supply wiring design support apparatus of a second embodiment;

FIG. 10 is a flowchart for illustrating a flow of a process of a power supply wiring design support method of the second embodiment;

FIG. 11 is a diagram showing an example of an X-direction voltage drop gradient in the power supply wiring design support method of the second embodiment;

FIG. 12 is a diagram showing an example of a Y-direction voltage drop gradient in the power supply wiring design support method of the second embodiment;

FIG. 13 is a diagram showing an example of an X-direction voltage drop gradient map in the power supply wiring design support method of the second embodiment; and

FIG. 14 is a diagram for illustrating an example of a Y-direction voltage drop gradient map in the power supply wiring design support method of the second embodiment.

### DETAILED DESCRIPTION

A power supply wiring design support method of an embodiment of the present invention includes: receiving input of information about multiple elements formed on a semiconductor chip and circuit information about the semiconductor chip; calculating a voltage drop of power supply voltage in each of areas into which the semiconductor chip is virtually divided based on a grid indicated by XY coordinates; and calculating a voltage drop gradient from the voltage drop of the area and voltage drops of adjacent areas.

### First Embodiment

First, a power supply wiring design support method, a power supply wiring design support apparatus, a power supply wiring design support program and a recording medium (hereinafter referred to as “the power supply wiring design support and the like”) of a first embodiment will be described.

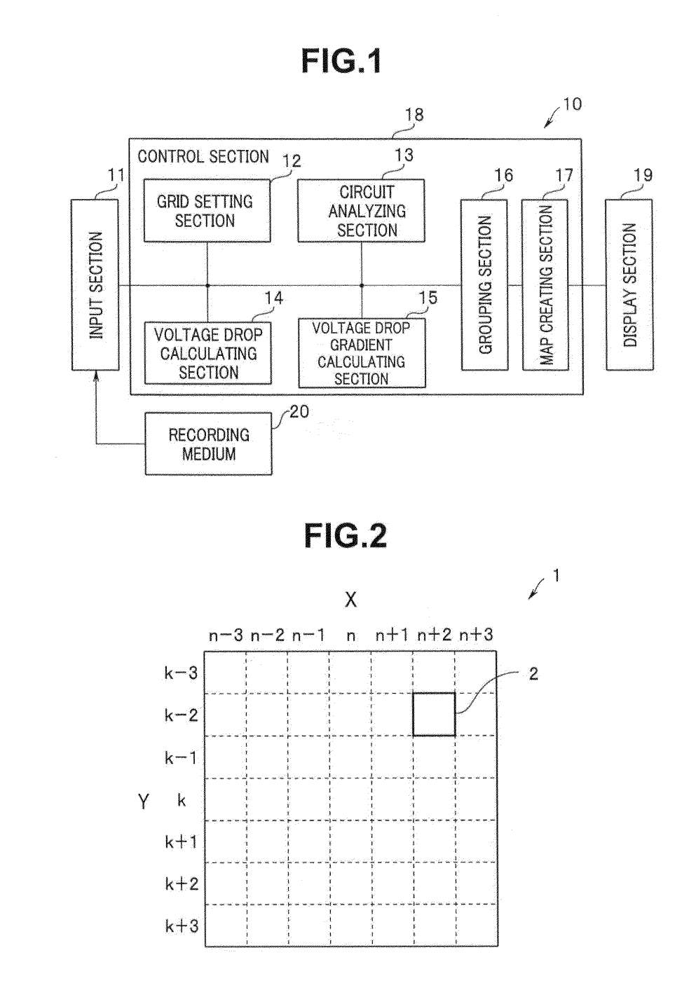

As shown in FIG. 1, the power supply wiring design support apparatus (hereinafter referred to as “the support apparatus”) 10 of the present embodiment is provided with an input section 11, a control section 18 and a display section 19. The control section 18 is provided with a grid setting section 12, a circuit analyzing section 13, a voltage drop calculating section 14, a voltage drop gradient calculating section (hereinafter referred to as “the gradient calculating section”) 15, a grouping section 16 and a map creating section 17.

The grid setting section 12, the circuit analyzing section 13, the voltage drop calculating section 14, the gradient calculating section 15, the grouping section 16 and the map creating section 17 are not necessarily required to be physically independent components. For example, the control section 18 may be a function of a computer executed by a program. For example, it is not necessary that the grouping section 16 and the map creating section 17, which do not operate at the same time, exist simultaneously. An area where the grouping section 16 of the control section 18 has operated may be used as the map creating section 17.

Information about multiple elements formed on a semiconductor chip, circuit information about the semiconductor chip and the like are inputted from the input section 11.

As shown in FIG. 2, the grid setting section 12 virtually divides the semiconductor chip into multiple areas 2 based on a grid indicated by XY coordinates, based on information from the input section 11. Each of the areas 2 of a semiconductor chip layout 1 generally includes multiple elements.

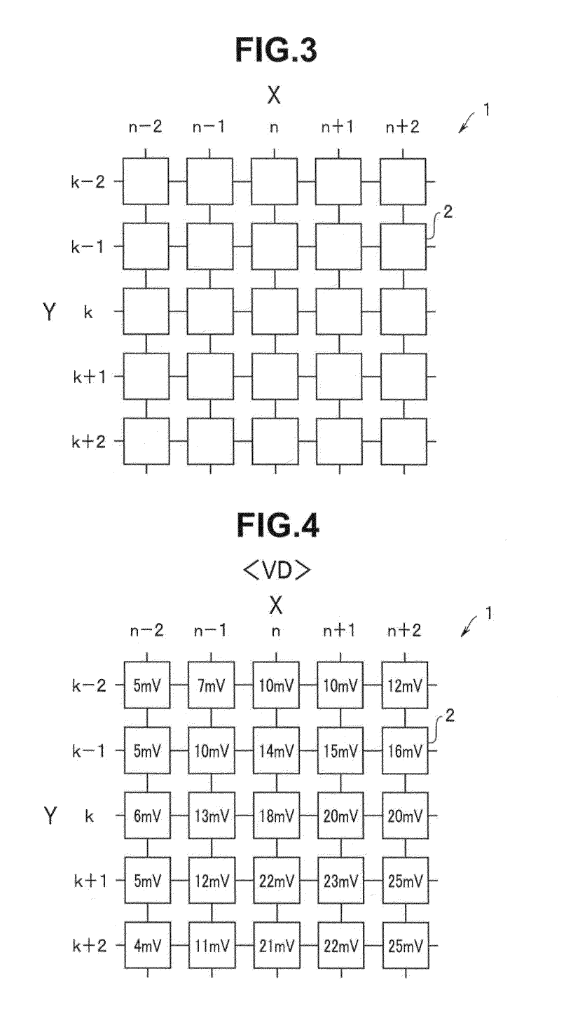

As shown in FIG. 3, it is assumed that the internal voltage of each area 2 is constant, and that each area 2 is electrically connected with four surrounding areas 2 via virtual wiring with a resistance of 0. That is, in a lot of semiconductor chips, power supply wires and ground wires are wired vertically and horizontally to the chip as a grid. Therefore, if it is possible to know power consumption and power supply current of a slit-shaped area formed between a side of a partial section of an X-direction horizontal axis and a Y-direction vertical axis relative to a chip, and a side of an opposing chip, relationship with a power supply wire supplying power to the area becomes clear, and it is convenient. Processing in consideration of a physical position in the chip is easier. The shape of the area 2 is not limited to a square. A rectangle is also possible. Furthermore, in the case of supplying power and current supplied to each area on the chip, from power supply/ground wiring in a particular shape, it is easy to write a circuit equation by considering resistance of elements and wiring expressing a voltage-current characteristic of each area.

In the layout 1 of a chip divided in areas, which is shown below, the virtual wiring may not be shown.

If the grid setting section 12 and the like are function sections executed by a program, the input section 11 has also an interface function for a computer-readable recording medium 20 which non-temporarily stores the program.

The circuit analyzing section 13 outputs power consumption information based on circuit connection information, circuit load information, circuit operation information and element power consumption information inputted from the input section 11. The process can be performed by an existing power consumption analysis tool.

As shown in FIG. 4, the voltage drop calculating section 14 outputs a voltage drop (VD) of each area 2 based on the circuit arrangement information and element physical information inputted from the input section 11 and the circuit power consumption information inputted from the circuit analyzing section 13. The process can be performed by an existing voltage drop analysis tool. In conventional power supply wiring design support, for example, voltage drops are displayed as a map (graphically displayed) on a layout of a semiconductor chip.

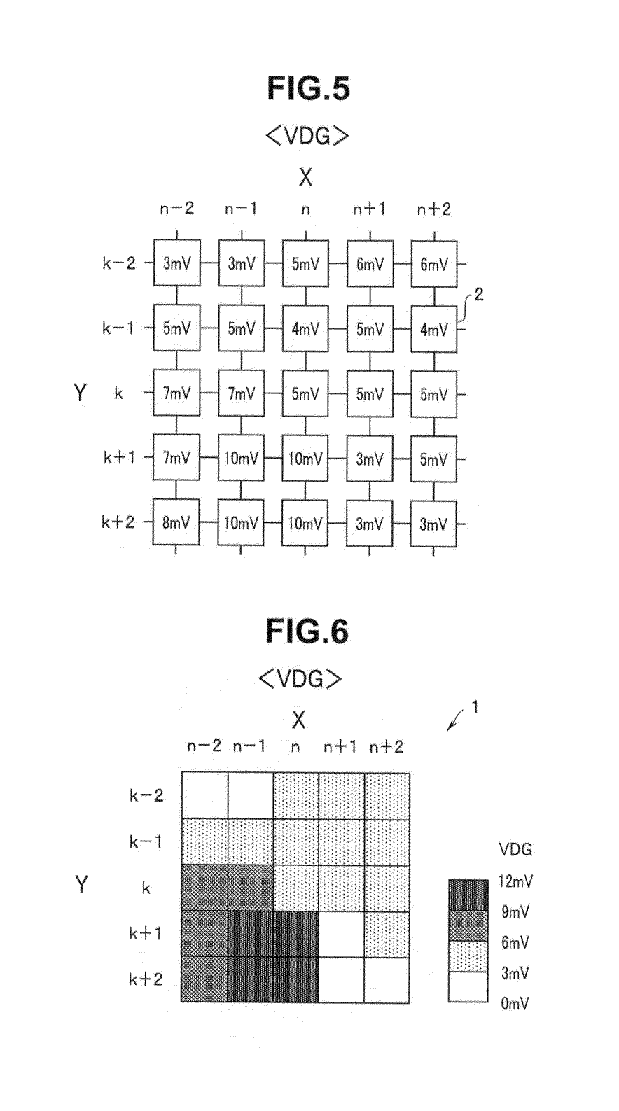

In comparison, the support apparatus 10 of the embodiment is further provided with the gradient calculating section 15. The process by the gradient calculating section 15 will be described in detail later. For example, as shown in FIG. 5, a largest value among differences between a VD of one area and VDs of four adjacent areas is calculated as a voltage drop gradient (VDG).

That is, the inventor found that, when power supply wiring in an area with a large voltage drop gradient is reinforced, a voltage drop of a chip can be effectively improved, as a result of keen endeavors. On the contrary, as for power supply wiring in an area with a small voltage drop gradient, the power drop does not deteriorate so much even if the power source wiring is decreased.

The grouping section 16 divides the multiple areas 2 into groups based on VDGs. The map creating section 17 creates a map in which the VDGs are mapped on a layout of a semiconductor chip, in accordance with the grouping by the grouping section 16. The display section 19 displays the VDG map created by the map creating section 17 as shown in FIG. 6.

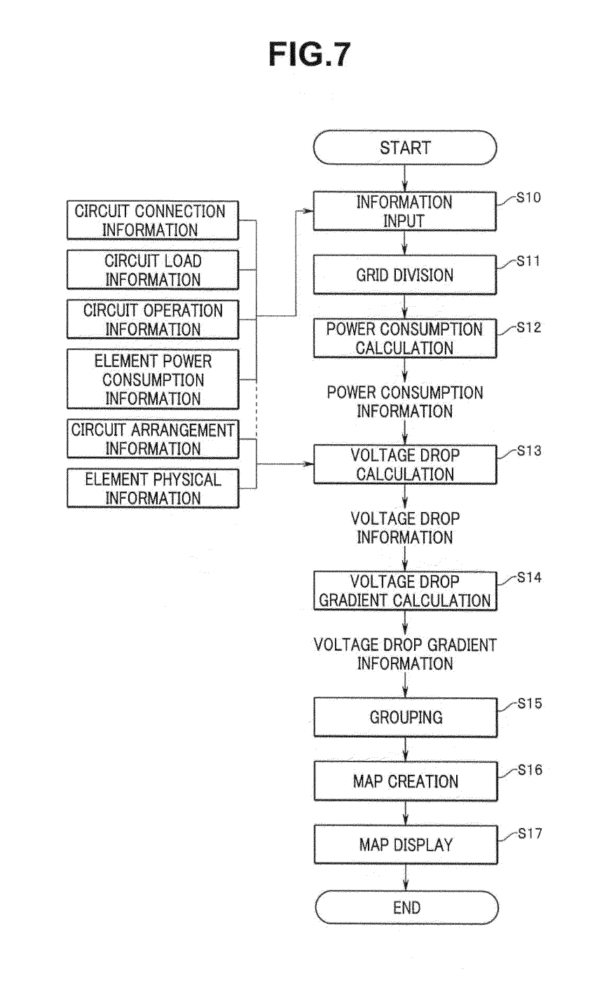

Next, the power supply wiring design support method of the support apparatus 10 will be described in accordance with a flowchart in FIG. 7.

### <Step S10>

Information about multiple elements formed on a semiconductor chip and circuit information about the semiconductor chip are inputted from the input section 11 to the control section 18.

The element information includes element power consumption information, element physical information and the like. The circuit information includes circuit connection information, circuit load information, circuit operation information and circuit arrangement information.

The element power consumption information is a library in which information for calculating power consumption of an element is described and is described, for example, in a format of Liberty, SPICE netlist or the like. The element physical information is a library describing physical information such as a size of an element and a position of a pin, and it is described, for example, in a format of LEF (library exchange format) or the like.

The circuit connection information is information describing connection relationships among elements in a circuit, and it is described, for example, in a format of Verilog-HDL (hardware description language) or the like. The circuit load information is information describing parasitic capacitance and parasitic resistance of signal wiring connecting the elements in the circuit, and it is described, for example, in a format of SPEF (standard parasitic exchange format), DSPF (detailed standard parasitic format) or the like. The circuit operation information is information describing how the elements in the circuit function, and it is described, for example, in a format of SDC (Synopsys design constraints) or the like. The circuit arrangement information is information describing arrangement positions of the elements in the circuit and positions of power supply wiring supplying power to the elements, and it is described, for example, in a format of DEF (design exchange format) or the like.

As shown in FIG. 7, it is sufficient if the circuit arrangement information, the element physical information and the like may be inputted before the latter-stage process.

If the grid setting section 12 and the like are function sections executed by a program, the program stored in the recording medium 20 is inputted to the control section 18 via the input section 11 before inputting the element information and the circuit information. The recording medium may be of any form if the recording medium can store a program and can be read by a computer. Specifically, for example, an internal storage device implemented in a computer, such as a ROM and a RAM, a portable storage medium such as a CD-ROM, a flexible disk, a DVD disk, a magneto-optical disk and an IC card, a database holding the program, another computer or a database of the computer, and the like can be given as the recording medium. Functions obtained by installation or download may be such that are realized in cooperation with an OS and the like inside the apparatus. A part or all of the program may be an execution module which is dynamically generated.

### <Step S11>

The semiconductor chip is virtually divided into multiple areas 2 based on a grid indicated by XY coordinates by the grid setting section 12. An element existing at a position where it is divided into multiple areas 2 is processed, being regarded as being included in any one area.

### <Step S12>

Power consumption information about each area 2 is calculated by the circuit analyzing section 13.

For example, power consumption of each element existing in each area is calculated based on the circuit information before the division, and, after that, power consumption information about the area, which is the total value thereof, is calculated. Alternatively, an area after the division may be regarded as one element to calculate the power consumption information about the area. In the former case, more accurate information can be acquired. In the latter case, information can be acquired at a faster speed.

### <Step S13>

A voltage drop (VD) of power supply voltage of each area is calculated by the voltage drop calculating section 14 based on the power consumption information.

In the example shown in FIG. 4, a VD at coordinates (X=n, Y=k), that is, the VD(n, k) is 18 mV.

### <Step S14>

A voltage drop gradient (VDG) is calculated by the gradient calculating section 15. In the support apparatus 10, the gradient calculating section 15 calculates a largest value among differences between the VD of one area and the VDs of four adjacent areas as the VDG.

That is, VDG(x, y), which is a VDG of coordinates (x, y), is calculated by Equation 1.

$$VDG ( x , y ) = max [ \begin{matrix}\begin{matrix}\begin{matrix}abs ( VD ( x , y ) - VD ( x - 1 , y ) ) , \\ abs ( VD ( x , y ) - VD ( x + 1 , y ) ) ,\end{matrix} \\ abs ( VD ( x , y ) - VD ( x , y - 1 ) ) ,\end{matrix} \\ abs ( VD ( x , y ) - VD ( x , y + 1 ) )\end{matrix} ] \qquad ( Equation 1 )$$

In the above equation, VDG(x, y), VD(x, y), abs( ) and max( ) indicate a voltage drop gradient of an area of the coordinates (x, y), a voltage drop of the area of the coordinates (x, y), a function for determining an absolute value and a function for determining a largest value, respectively.

In FIG. 4, VD(n, k)=18, VD(n−1, k)=13, VD(n+1, k)=20, VD(n, k−1)=14 and VD(n, k+1)=22 are satisfied. Therefore, for example, abs(VD(n, k)−VD(n−1, k)=abs(18−13)=5 is obtained. As shown in FIG. 5, VDG(n, k)=max(5, 2, 4, 4)=5 (mV) is obtained.

### <Step S15>

The grouping section 16 divides the areas into groups based on the VDGs. For example, areas of VDG=0 to 3 mV belong to A group; areas of VDG=3 to 6 mV belong to B group, areas of VDG=6 to 9 mV belong to C group; and areas of VDG=9 to 12 mV belong to D group. The criteria for grouping are appropriately determined based on the largest value of VDG or the like.

### <Step S16>

A VDG map is created by the map creating section 17 in which a layout of the semiconductor chip showing the multiple areas is displayed with each group shown in a different color or pattern.

### <Step S17>

The VDG map created by the map creating section 17 is displayed on the display section 19. In the example shown in FIG. 6, areas are displayed in different patterns according to groups.

As described above, the power supply wiring design support method of the embodiment includes:

receiving input of information about multiple elements formed on a semiconductor chip and circuit information about the semiconductor chip;

calculating a voltage drop of power supply voltage in each of areas into which the semiconductor chip is virtually divided based on a grid indicated by XY coordinates; and

calculating a voltage drop gradient from the voltage drop of the area and voltage drops of adjacent areas.

A power supply wiring design support apparatus of another embodiment includes:

an input section configured for receiving input of information about multiple elements formed on a semiconductor chip and circuit information about the semiconductor chip;

a voltage drop calculating section configured to calculate a voltage drop of power supply voltage in each of areas into which the semiconductor chip is virtually divided based on a grid indicated by XY coordinates; and

a voltage drop gradient calculating section configured to calculate a voltage drop gradient from the voltage drop of the area and voltage drops of adjacent areas.

A power supply wiring design support program of another embodiment causes a control section of a computer to execute the power supply wiring design support method described above.

A recording medium 20 of another embodiment is a computer-readable medium which non-temporarily stores the power supply wiring design support program described above.

In a conventional power supply wiring design support system for a semiconductor chip which is capable of only identifying an area with a large voltage drop, there is a possibility that optimum reinforcement of power supply wiring cannot be performed. In another conventional power supply wiring design support system, since power supply wiring to be reinforced is limited to a current route which flows into a node with a largest voltage drop, there is a possibility that optimum reinforcement of power supply wiring cannot be performed. Furthermore, it is necessary for a semiconductor designer to make judgment for reinforcement of power supply wiring, adding various factors other than voltage drops, such as possibility of signal wiring.

In comparison, according to the power supply wiring design support method and the like according to the embodiments, it is possible to present an indicator for effective reinforcement of power supply wiring to a circuit designer. Furthermore, it is possible to intelligibly display a voltage drop gradient in an area corresponding to physical coordinates for the circuit designer. That is, the circuit designer can easily perform effective reinforcement of power supply wiring because he can easily identify coordinates (an area) where the voltage drop gradient is large and coordinates (an area) where the voltage drop gradient is small.

The voltage drop gradient (VDG) is not limited to a largest value among differences (variations) from VDs of four adjacent areas. For example, an average value among the differences from the VDs of four adjacent areas may be calculated as the VDG. Furthermore, an approximate expression for approximating the VD corresponding to the coordinates, for example, an interpolating polynominal may be calculated to set a derivative of the approximate expression (interpolating polynominal) as the VDG.

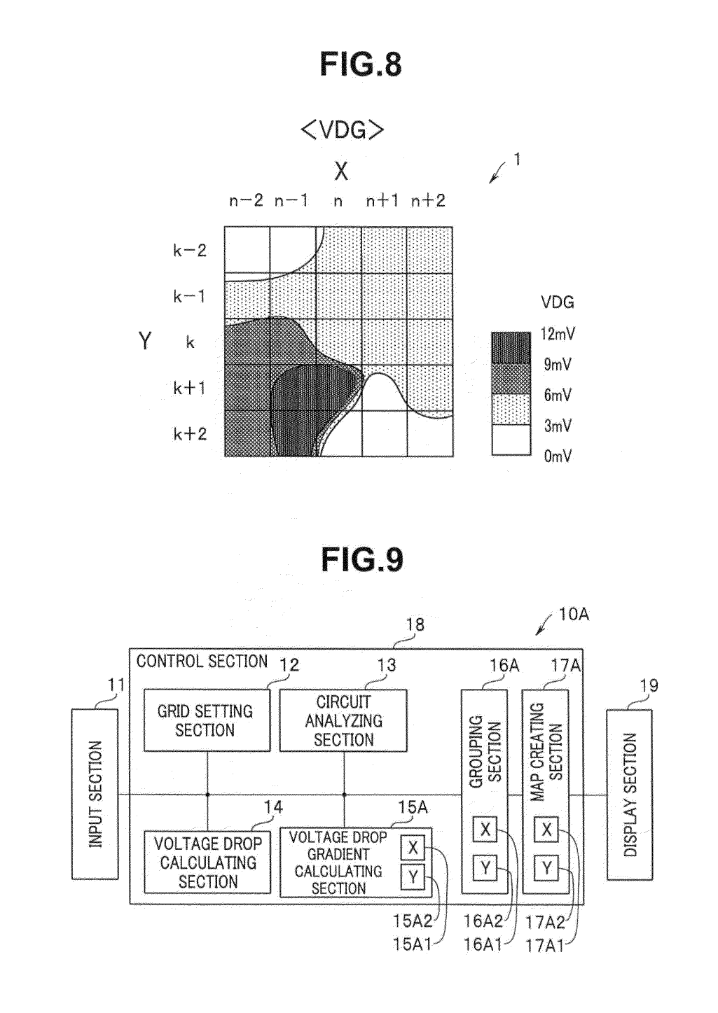

Furthermore, it is also possible to calculate borderlines among the groups in the VDG map display on the layout of the semiconductor chip and smoothly interpolate the borders as shown in FIG. 8 to display them in contours.

### Second Embodiment

Next, a power supply wiring design support apparatus 10A and the like according to a second embodiment will be described. Since the power supply wiring design support apparatus 10A and the like are similar to the power supply wiring design support apparatus 10 and the like according to the first embodiment, only different points will be described.

As shown in FIG. 9, a voltage drop gradient calculating section 15A of the support apparatus 10A has an X-direction gradient calculating section 15A1 and a Y-direction gradient calculating section 15A2. A grouping section 16A has an X-direction grouping section 16A1 and a Y-direction grouping section 16A2. A map creating section 17A has an X-direction map creating section 17A1 and a Y-direction map creating section 17A2.

Based on voltage drops (VDs) calculated by the voltage drop calculating section 14, the X-direction gradient calculating section 15A1 calculates an X-direction voltage drop gradient (VDG_X), and the Y-direction gradient calculating section 15A2 calculates a Y-direction voltage drop gradient (VDG_Y). The X-direction grouping section 16A1 divides multiple areas 2 into groups based on the X-direction voltage drop gradient (VDG_X), and the Y-direction grouping section 16A2 divides the multiple areas 2 into groups based on the Y-direction voltage drop gradient (VDG_Y). The X-direction map creating section 17A1 creates a VDG map in which the VDGs are mapped onto a layout of a semiconductor chip in accordance with the grouping by the X-direction grouping section 16A1, and the Y-direction map creating section 17A2 creates the VDG map in which the VDGs are mapped onto the layout of the semiconductor chip in accordance with the grouping by the Y-direction grouping section 16A2.

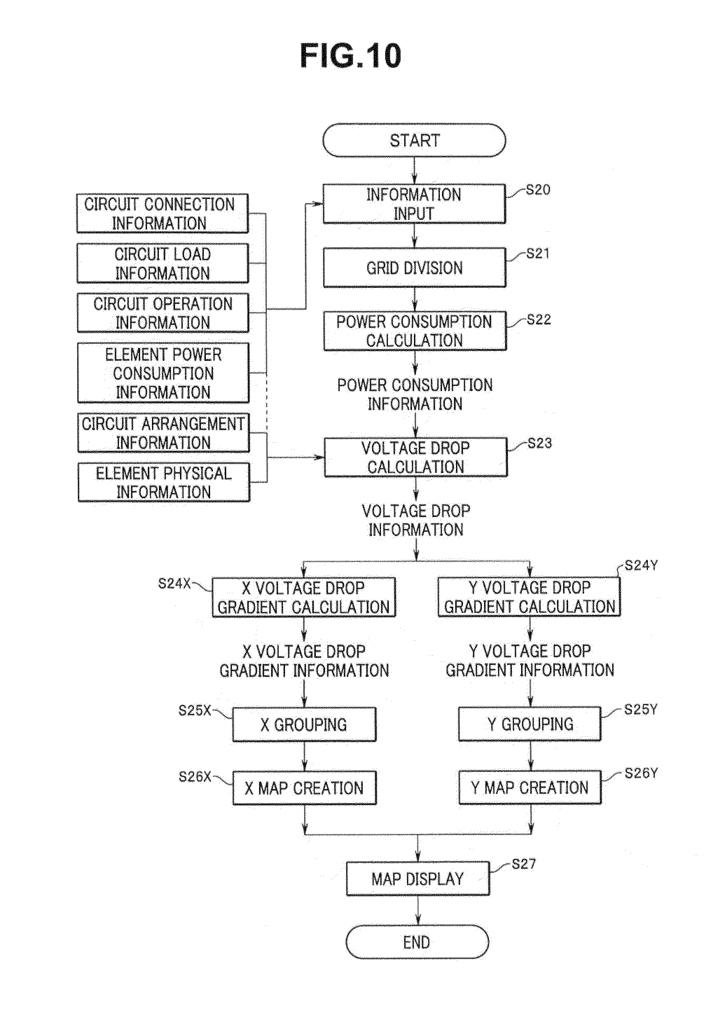

Next, a power supply wiring design support method of the support apparatus 10A will be described in accordance with a flowchart in FIG. 10. Since the flowchart in FIG. 10 is similar to the flowchart in FIG. 7, only different points will be described.

### <Steps S20 to S23>

These steps are the same as steps S10 to S13 in FIG. 7.

### <Step S24X>

The X-direction gradient calculating section 15A1 calculates the X-direction voltage drop gradient (VDG_X). The X-direction gradient calculating section 15A1 calculates a largest value among differences between a VD of one area and VDs of two areas which are adjacent to the one area in the X direction, as a VDG_X. That is, VDG_X (x, y) is calculated by Equation 2.

$$VDG\_X ( x , y ) = max [ \begin{matrix}abs ( VD ( x , y ) - VD ( x - 1 , y ) ) , \\ abs ( VD ( x , y ) - VD ( x + 1 , y ) )\end{matrix} ] \qquad ( Equation 2 )$$

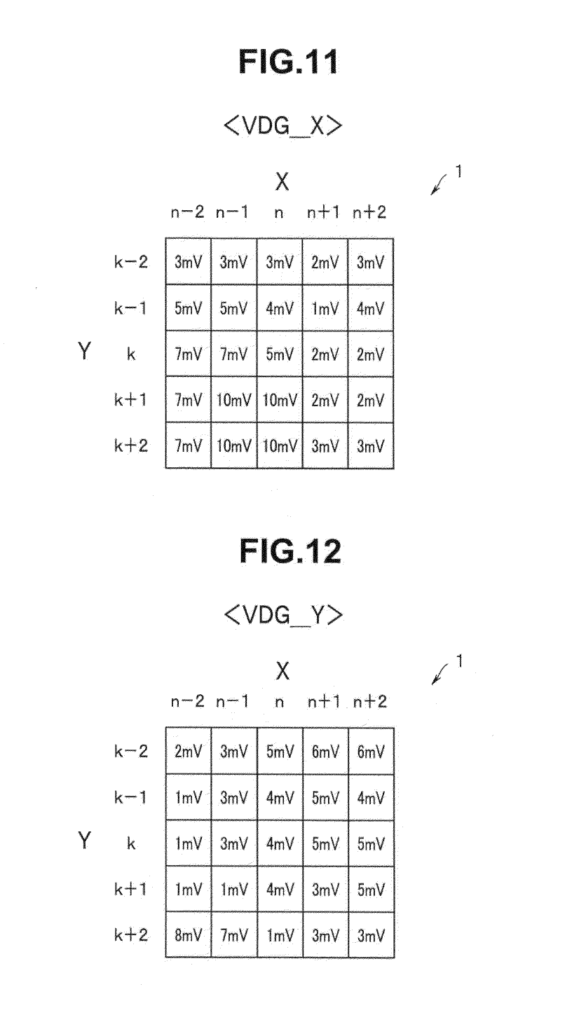

In FIG. 4, VD(n, k)=18, VD(n−1, k)=13, VD(n+1, k)=20 are satisfied. Therefore, as shown in FIG. 11, VDG_X(n, k)=max(5, 2)=5 (mV) is obtained.

### <Step S25X>

The X-direction grouping section 16A1 divides the multiple areas 2 into groups based on VDG Xs. For example, areas of VDG=0 to 3 mV belong to A group; areas of VDG=3 to 6 mV belong to B group, areas of VDG=6 to 9 mV belong to C group; and areas of VDG=9 to 12 mV belong to D group. The criteria for grouping are appropriately determined based on the largest value of VDG or the like.

### <Step S26X>

An X-direction map creating section 17X1 creates a map in which the areas are displayed in different colors or patterns, respectively, according to the groups divided by the X-direction grouping section 16A1.

### <Step S24Y>

The Y-direction gradient calculating section 15A2 calculates the Y-direction voltage drop gradient (VDG_Y). The Y-direction gradient calculating section 15A2 calculates a largest value among differences between a VD of one area and the VDs of two areas which are adjacent to the one area in the Y direction, as a VDGY.

That is, VDG_Y (x, y) is calculated by Equation 3.

$$VDG\_Y ( x , y ) = max [ \begin{matrix}abs ( VD ( x , y ) - VD ( x , y - 1 ) ) , \\ abs ( VD ( x , y ) - VD ( x , y + 1 ) )\end{matrix} ] \qquad ( Equation 3 )$$

In FIG. 4, VD(n, k)=18, VD(n, k−1)=14, VD(n, k+1)=22 are satisfied. Therefore, as shown in FIG. 12, VDG_Y(n, k)=4 (mV) is obtained.

### <Step S25Y>

The Y-direction grouping section 16A2 divides the multiple areas 2 into groups based on the VDG_Ys in a method similar to that of the X-direction grouping section 16A1.

### <Step S26Y>

A Y-direction map creating section 17X2 creates a map in which the areas are displayed in different colors or patterns according to the groups divided by the Y-direction grouping section 16A2.

In the power supply wiring design support method of the support apparatus 10A shown in FIG. 10, the X-direction process (S24X to S26X) and the Y-direction process (S24Y to S26Y) are performed in parallel. However, it is also possible to perform the Y-direction process after the X-direction process ends.

### <Step S27>

In a step of displaying voltage drop vertical and horizontal gradients, circuit voltage drop vertical direction (Y-direction) gradient information and circuit voltage drop horizontal direction (X-direction) gradient information are inputted to the display section 19, and a vertical gradient and a horizontal gradient are graphically displayed.

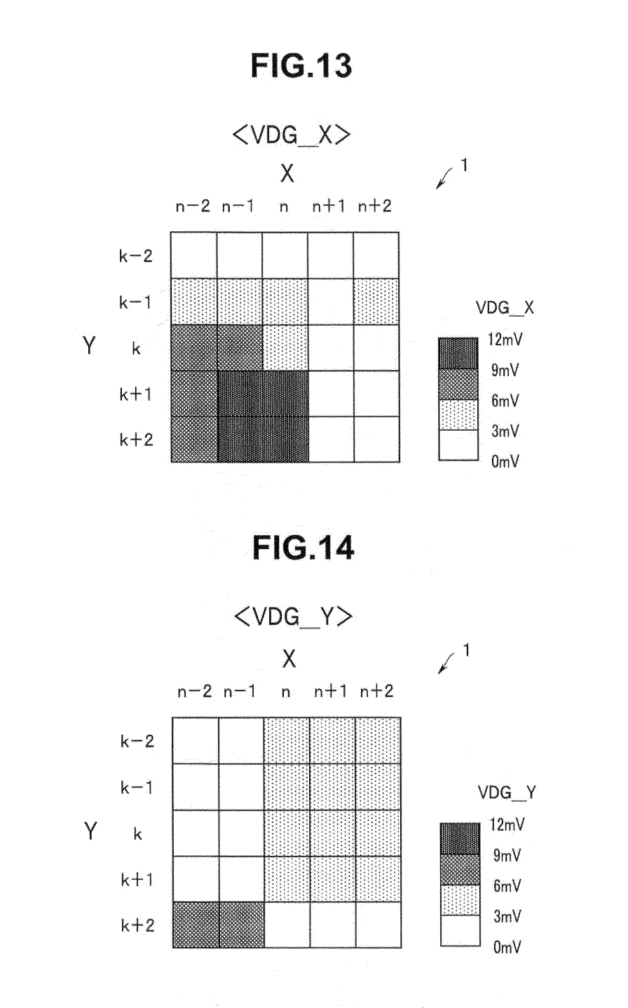

FIG. 13 shows the graphic display example of the horizontal direction (X-direction) gradient information in FIG. 11. FIG. 14 shows the graphic display example of the vertical direction (Y-direction) gradient information in FIG. 12. In FIGS. 13 and 14, the voltage drop gradients are divided into groups for each value, and the respective groups are displayed with different patterns. In addition, the examples are different from the display of the voltage drop gradients in the first embodiment in that the vertical direction (Y-direction) voltage gradient and the horizontal direction (X-direction) voltage gradient are independently displayed.

It should be noted that, in the graphic display, the voltage drop gradients may be displayed with different colors instead of the patterns according to the groups.

That is, the two maps created by the X-direction map creating section 17X1 and the Y-direction map creating section 17X2 are displayed on the display section 19. The two maps may be displayed on the same screen at the same time. One of the maps may be displayed in accordance with a user's instruction.

In the support apparatus 10A also, the voltage drop gradients (the VDG_X and the VDG_Y) are not limited to a largest value between differences (variations) from VDs of two adjacent areas, similar to the support apparatus 10. For example, an average value between the differences from the VDs of two adjacent areas may be calculated as the VDG. Furthermore, an approximate expression (interpolating polynominal) for approximating the VD corresponding to the coordinates may be calculated to set derivatives of the approximate expression (interpolating polynominal) as the VDG_X and the VDG_Y.

Furthermore, it is also possible to calculate borderlines among the groups in the VDG_X and VDG_Y map displays on the layout of the semiconductor chip to smoothly display them in contours as shown in FIG. 8.

According to the support apparatus 10A, it is possible to intelligibly display the X-direction voltage drop gradient VDG_X and the Y-direction voltage drop gradient VDG_Y separately. Therefore, the circuit designer can separately and easily identify an area with a large voltage drop gradient and an area with a small voltage drop gradient in the X and Y directions.

In general, power supply wiring of a semiconductor integrated circuit is configured by X-direction wiring and Y-direction wiring. Therefore, according to the support apparatus 10A, it is possible to intelligibly display candidate positions where power supply wiring is to be reinforced or candidate positions where power supply wiring can be decreased in the X-direction wiring and the Y-direction wiring separately, for the circuit designer.

The support apparatus 10A and the like have the advantages of the support apparatus 10 and the like, and power supply wiring design can be performed more effectively by the support apparatus 10A.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A power supply wiring design support method comprising:
receiving input of information about multiple elements formed on a semiconductor chip and circuit information about the semiconductor chip;
calculating a voltage drop of power supply voltage in each of areas into which the semiconductor chip is virtually divided based on a grid indicated by XY coordinates; and
calculating a voltage drop gradient from the voltage drop of the area and voltage drops of adjacent areas.

2. The power supply wiring design support method of claim 1, further comprising:
dividing the multiple areas into groups based on the voltage drop gradients; and
displaying, as a map, a semiconductor chip layout in which the multiple areas are displayed in different colors or patterns according to the groups.

3. The power supply wiring design support method of claim 2, wherein an X-direction voltage drop gradient based on voltage drops of areas adjacent in an X direction and a Y-direction voltage drop gradient based on voltage drops of areas adjacent in a Y direction are calculated.

4. The power supply wiring design support method of claim 3, wherein the voltage drop gradient is a largest value among differences between the voltage drop of the area and the voltage drops of the multiple adjacent areas.

5. The power supply wiring design support method of claim 3, wherein the voltage drop gradient is an average value among the differences between the voltage drop of the area and the voltage drops of the adjacent multiple areas.

6. The power supply wiring design support method of claim 3, wherein the voltage drop gradient is a derivative of an approximate expression for approximating the voltage drop corresponding to the coordinates.

7. A power supply wiring design support apparatus comprising:
an input section configured for receiving input of information about multiple elements formed on a semiconductor chip and circuit information about the semiconductor chip;
a voltage drop calculating section configured to calculate a voltage drop of power supply voltage in each of areas into which the semiconductor chip is virtually divided based on a grid indicated by XY coordinates; and
a voltage drop gradient calculating section configured to calculate a voltage drop gradient from the voltage drop of the area and voltage drops of adjacent areas.

8. The power supply wiring design support apparatus of claim 7, further comprising:
a grouping section configured to divide the multiple areas into groups based on the voltage drop gradient; and
a display section configured to display, as a map, a semiconductor chip layout in which the multiple areas are displayed in different colors or patterns according to the groups.

9. The power supply wiring design support apparatus of claim 8, wherein the voltage drop gradient calculating section calculates an X-direction voltage drop gradient based on voltage drops of areas adjacent in an X direction and a Y-direction voltage drop gradient based on voltage drops of areas adjacent in a Y direction.

10. The power supply wiring design support apparatus of claim 9, wherein the voltage drop gradient calculated by the voltage drop gradient calculating section is a largest value among differences between the voltage drop of the area and the voltage drops of the adjacent multiple areas.

11. The power supply wiring design support apparatus of claim 9, wherein the voltage drop gradient calculated by the voltage drop gradient calculating section is an average value among the differences between the voltage drop of the area and the voltage drops of the adjacent multiple areas.

12. The power supply wiring design support apparatus of claim 9, wherein the voltage drop gradient calculated by the voltage drop gradient calculating section is a derivative of an approximate expression for approximating the voltage drop corresponding to the coordinates.

13. A computer-readable recording medium non-temporarily storing a power supply wiring design support program executed by a control section of a computer, the power supply wiring design support program comprising:
receiving input of information about multiple elements formed on a semiconductor chip and circuit information about the semiconductor chip;
calculating a voltage drop of power supply voltage in each of areas into which the semiconductor chip is virtually divided based on a grid indicated by XY coordinates;
calculating a voltage drop gradient from the voltage drop of the area and voltage drops of adjacent areas;
dividing the multiple areas into groups based on the voltage drop gradient; and
displaying a semiconductor chip layout in which the multiple areas are displayed in different colors or patterns according to the groups.

14. The recording medium of claim 13, wherein the power supply wiring design support program further comprises:
dividing the multiple areas into groups based on the voltage drop gradient; and
displaying, as a map, a semiconductor chip layout in which the multiple areas are displayed in different colors or patterns according to the groups.

15. The recording medium of claim 13, wherein an X-direction voltage drop gradient based on voltage drops of areas adjacent in an X direction and a Y-direction voltage drop gradient based on voltage drops of areas adjacent in a Y direction are calculated.

16. The recording medium of claim 15, wherein the voltage drop gradient is a largest value among differences between the voltage drop of the area and the voltage drops of the adjacent multiple areas.

17. The recording medium of claim 15, wherein the voltage drop gradient is an average value among the differences between the voltage drop of the area and the voltage drops of the adjacent multiple areas.

18. The recording medium of claim 15, wherein the voltage drop gradient is a derivative of an approximate expression for approximating the voltage drop corresponding to the coordinates.
